(19) United States
(12) Patent Application Publication
(10) Pub. No.: US 2005/0239415 A1
(43) Pub. Date: Oct. 27, 2005

(54) High-frequency switch circuit and high-frequency transmitting/receiving apparatus

(76) Inventors: Yoshitomo Sagae, Yokohama-shi (JP); Toshiki Seshita, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/883,697

(22) Filed: Jul. 6, 2004

(30) Foreign Application Priority Data
Apr. 27, 2004 (JP) 2004-131608

(51) Int. Cl. H04B 1/38; H04B 1/44; H01P 3/00; H01P 9/00

(52) U.S. Cl. 455/78; 455/73

(57) ABSTRACT

A high-frequency switch circuit includes a first terminal which receives a transmission signal, a first FET which makes a path of the transmission signal conductive or cut off, a second terminal which receives a control signal that is inactive in a transmitting mode and is active in a receiving mode, a ground terminal which is grounded via a first capacitor, and a second FET which has a drain electrode, a source electrode and a gate electrode, the drain or source electrode being connected to the ground terminal, the source or drain electrode being connected to first terminal, and the gate electrode being connected to the second terminal, and which has a greater off-capacitance for unit gate width than the first FET.

### CROSS-REFERENCE TO RELATED APPLICATIONS

This application is based upon and claims the benefit of priority from prior Japanese Patent Application No. 2004-131608, filed Apr. 27, 2004, the entire contents of which are incorporated herein by reference.

### BACKGROUND OF THE INVENTION

1. Field of the Invention

The present invention relates to a high-frequency switch circuit that can switch a high-frequency signal-transmitting mode to a high-frequency signal-receiving mode, and vice versa. More particularly, the invention relates to an SPDT (Single-Pole Double-Throw) switch that handles high-frequency signals.

2. Description of the Related Art

Generally, a SPDT switch is incorporated in high-frequency communications apparatuses such as mobile telephones. The SPDT switch includes a semiconductor switch for switching the signal transmission to the reception of signal and vice versa. The SPDT switch is a high-frequency switch that receives a signal from an input terminal and supplies the signal to one of two output terminals connected to two signal lines, respectively.

FIG. 10 is a circuit diagram of a conventional SPDT switch. This SPDT switch has an antenna terminal ANT, a transmission terminal TX, a receipt terminal RX, two control terminals CON1 and CON2, and a power-supply voltage terminal VD. The terminal ANT is connected to an antenna. A signal is supplied to the terminal TX so that it may be transmitted from the terminal RX.

The power-supply voltage is applied to the terminal VD. The terminal VD is connected to a decoupling capacitor Cp, which is connected to the ground. In other words, the terminal VD is grounded for a high-frequency signal, and receives a power-supply voltage Vdd for a direct current (DC).

The SPDT switch further has a transmitting-side through-FET (Field-Effect Transistor) Q1, a receiving-side through-FET Q2, a transmitting-side shunt FET Q3, a receiving-side shunt FET Q4, and five resistors R1, R2, R3, R4 and R5.

The through-FET Q1 is provided between, and connected to, the terminals TX and ANT. The through-FET Q2 is provided between, and connected to, the terminals RX and ANT. The shunt FET Q3 is provided between, and connected to, the terminals TX and VD. The shunt FET Q4 is provided between, and connected to, the terminals RX and VD.

The resistor R1 connects the gate electrode of the through-FET Q1 to the control terminal CON1. The resistor R2 connects the gate electrode of the through-FET Q2 to the control terminal CON2. The resistor R3 connects the gate electrode of the shunt FET Q3 to the control terminal CON2. The resistor R4 connects the gate electrode of the shunt FET Q4 to the control terminal CON1. The resistor R5 connects the terminal ANT to the terminal VD.

The FETs Q1, Q2, Q3 and Q4 have a negative threshold voltage Vth. The threshold voltage Vth falls within the range of 0 V to −|Vdd|V. The threshold voltage is, for example, about −1 V if the power-supply voltage Vdd is about 3 V. As FIG. 10 shows, the DC potential at the source or drain electrode of every FET provided in the SPDT switch is the power-supply voltage Vdd.

A control signal Vcon1 is supplied to the control terminal CON1. A control signal Von2 is supplied to the control terminal CON2. The control signals Vcon1 and Vcon2 are complementary to each other.

When the control signal Vcon1 is at the high level (e.g., 3 V) and the control signal Vcon2 is at the low level (e.g., 0 V), the through-FET Q1 and the shunt FET Q4 are on and the through-FET Q2 and the shunt FET Q3 are off. In this case, the terminals TX and ANT are connected, whereas the terminals ANT and RX are disconnected. Thus, the SPDT switch is set in the transmitting mode. When the control signal Vcon1 is at the low level and the control signal Vcon2 is at the high level, the through-FET Q1 and the shunt FET Q4 are off and the through-FET Q2 and the shunt FET Q3 are on. If this is the case, the terminals TX and ANT are disconnected, whereas the terminals ANT and RX are connected. Thus, the SPDT switch is set in the receiving mode.

FIG. 11 is an equivalent-circuit diagram that represents the SPDT switch of FIG. 10 that remains in the transmitting mode. In FIG. 11, Ron1 and Ron4 are the on-resistances of the FETs Q1 and Q4, respectively (each being the resistance existing between the source electrode and drain electrode while the FET remains on.) Coff2 and Coff3 are the off-capacitances of the FETs Q2 and Q3, respectively (each being the capacitance existing between the source electrode and drain electrode while the FET remains off.) If the on-resistance and the off-capacitance are zero, the SPDT switch is an ideal one that has no insertion loss and infinite isolation. In effect, however, the on resistance and the off-capacitance are limited. Inevitably, the SPDT has an insertion loss even if it assumes the through state, and has a limited isolation even if it assumes the off state.

The SPDT switch shown in FIG. 10 has parasitic inductances Ls1, Ls2, Ls3 and Ls4. These parasitic inductances result from the leads and bonding wires of the package containing the circuit. (The leads electrically connect the package to the external terminals provided on the substrate on which the package is mounted.)

The parasitic inductance at each lead of an ordinary molded package is about 0.5 nH. The parasitic inductance at each bonding wire of the molded package is about 1 nH. Hence, the parasitic inductances Ls1, Ls2, Ls3 and Ls4 are about 1.5 nH. They adversely influence the characteristics of the SPDT switch.

FIG. 12 is a graph illustrating the relation between the transmission loss and reflection loss, on the one hand, and the parasitic inductance, on the other, which is observed in the circuit of FIG. 11. Assume that the terminal RX is terminated at resistance of 50 Ω. Also assume that Ls=Ls1=Ls2=Ls3=Ls4, Ron1=2 Ω, Ron4=8 Ω, Coff2=240 fF, Coff3=60 fF, and the frequency=2.5 GHz.

The “transmission loss” is a loss observed when a high-frequency signal travels from the transmission terminal TX to the antenna terminal ANT. The term “reflection loss” is a loss observed when the internal circuit connected to the transmission terminal TX reflects the high-frequency signal input to the transmitting terminal TX. The transmission loss is represented as |S12| when the terminals TX and ANT are used as port 1 and port 2, respectively. Note that “S” is an S parameter (the high-frequency characteristic constant).

The transmission loss is an important factor that greatly determines the characteristics of the SPDT switch. Nonetheless, the reflective loss that is included in the transmission loss is plotted in FIG. 12, too. As seen from FIG. 12, the transmission loss is minimal when the parasitic inductance Ls is 0.4 nH. This is probably because the reflection loss is also minimal at the parasitic inductance of 0.4 nH. The transmission loss increases as the parasitic inductance Ls increases above 0.4 nH. The transmission loss is 0.605 dB when the parasitic inductance Ls takes the above-mentioned practical value of 1.5 nH. Of this value, 0.403 dB is the reflective loss.

As can be understood from the above, the conventional SPDT switch has a large transmission loss due to the parasitic inductance of the leads and bonding wires of the package.

A switch circuit that has a small transmission loss has been proposed, as in Jpn. Pat. Appln. KOKAI Publication 2003-101304. In this circuit, capacitance elements are connected in parallel to FETs that constitute an SPDT switch. Let us consider, for example, a combination of a high-frequency (2.5 GHz) power amplifier and an output-matching circuit. The power amplifier has an output impedance of, for example, 15 Ω. The output-matching circuit can be a low-pass LC circuit that comprises an inductor having inductance Lx and a capacitor having capacitance Cx. The inductor is connected in series to the output of the high-frequency power amplifier and the transmitting terminal of an SPDT switch. The capacitor is provided between, and connected to, the transmitting terminal and ground terminal of the SPDT switch.

To change the output impedance of the high-frequency power amplifier, from 15 Ω to 50 Ω, inductance Lx and capacitance Cx should have the following values:
Lx≈1.5 nH
Cx≈2 pF

To provide this output-matching circuit, the capacitance element connected to the shunt FET Q3 should have capacitance of about 1.94 pF if the shunt FET Q3 has off-capacitance Coff3 of 60 fF.

This capacitance element may be an MIM (Metal Insulator Metal) capacitor that has an insulating film made of SiN and having a thickness of 200 nm. Then, the element occupies an area of 6,800 μm² if it is square-shaped (one side: about 82 μm long). This increases the area of the output-matching circuit and, ultimately, the manufacturing cost thereof.

### BRIEF SUMMARY OF THE INVENTION

A high-frequency switch circuit according to a first aspect of this invention switches between a transmitting mode of inputting and outputting a transmission signal and a receiving mode of inputting and outputting a reception signal. The switch circuit comprises: a first terminal which receives the transmission signal; a first FET which makes a path of the transmission signal conductive or cut off; a second terminal which receives a control signal that is inactive in the transmitting mode and is active in the receiving mode; a ground terminal which is grounded via a first capacitor; and a second FET which has a drain electrode, a source electrode and a gate electrode, the drain or source electrode being connected to the ground terminal, the source or drain electrode being connected to first terminal, and the gate electrode being connected to the second terminal, and which has a greater off-capacitance for unit gate width than the first FET.

A high-frequency transmitting/receiving apparatus according to a second aspect of this invention comprises: a dielectric substrate; a high-frequency power amplifier which is provided on the dielectric substrate and which amplifies a transmission signal; an inductor connected at one end to a power-supply voltage and at the other end connected to an output of the high-frequency power amplifier; and a high-frequency switch circuit which is provided on the dielectric substrate, which is sealed in a package substrate and which switches between a transmitting mode of inputting and outputting the transmission signal and a receiving mode of inputting and outputting a reception signal. The switch circuit comprises: a first terminal which receives the transmission signal; a wiring portion which connects a first node to the first terminal; a first FET which has a drain electrode, a source electrode and a gate electrode, the drain or source electrode being connected to the first node, and which makes a path of the transmission signal conductive or cut off; a second terminal which receives a control signal that is inactive in the transmitting mode and is active in the receiving mode; a ground terminal which is grounded via a first capacitor; and a second FET which has a drain electrode, a source electrode and a gate electrode, the drain or source electrode being connected to the first node, the source or drain electrode being connected to the ground terminal, and the gate electrode being connected to the second terminal, and which has a greater off-capacitance for unit gate width than the first FET, the second FET having an off-capacitance, and the wiring portion having inductance, the off-capacitance and the inductance performing impedance matching on the high-frequency power amplifier.

A high-frequency transmitting/receiving apparatus according to a third aspect of this invention comprises: a dielectric substrate; a high-frequency power amplifier which is provided on the dielectric substrate and which amplifies a transmission signal; an inductor connected at one end to a power-supply voltage and at the other end connected to an output of the high-frequency power amplifier; and a high-frequency switch circuit which is provided on the dielectric substrate and which switches between a transmitting mode of inputting and outputting the transmission signal and a receiving mode of inputting and outputting a reception signal. The switch circuit comprises: a first terminal which receives the transmission signal; a first FET which makes a path of the transmission signal conductive or cut off; a second terminal which receives a control signal that is inactive in the transmitting mode and is active in the receiving mode; a ground terminal which is grounded via a first capacitor; a second FET which has a drain electrode, a source electrode and a gate electrode, the drain or source electrode being connected to the first terminal, the source or drain electrode being connected to the ground terminal, and the gate electrode being connected to the second terminal, and which has a greater off-capacitance for unit gate width than the first FET, and a wiring portion which connects the first terminal to the output of the high-frequency power amplifier, the second FET having an off-capacitance, and the wiring portion having inductance, the off-capacitance and the inductance performing impedance matching on the high-frequency power amplifier.

### BRIEF DESCRIPTION OF THE SEVERAL VIEWS OF THE DRAWING

FIG. 1 is a circuit diagram showing an SPDT switch according to a first embodiment of the present invention;

FIG. 2 is a sectional view of a packaged SPDT switch according to the first embodiment;

FIG. 3 is a sectional view illustrating the structure of the shunt FET Q3 shown in FIG. 1;

FIG. 4 is an equivalent-circuit diagram of the off-capacitance at the shunt FET Q3 shown in FIG. 3;

FIG. 5 is a sectional view depicting the structure of the transmitting-side shunt FET Q3 incorporated in a second embodiment of this invention;

FIG. 6 is an equivalent-circuit diagram of the off-capacitance at the shunt FET Q3 shown in FIG. 5;

FIG. 7 is a sectional view depicting the structure of the transmitting-side shunt FET Q3 provided in a third embodiment of the invention;

FIG. 8 is an equivalent-circuit diagram of the off-capacitance at the shunt FET Q3 shown in FIG. 7;

FIG. 9 is a circuit diagram showing the configuration of a high-frequency transmitting/receiving apparatus 300 according to a fourth embodiment of the invention;

FIG. 10 is a circuit diagram depicting a conventional SPDT switch;

FIG. 11 is an equivalent-circuit diagram of the SPDT switch shown in FIG. 10, which is operating in the transmitting mode; and

FIG. 12 is a graph representing the relation between the transmission loss and reflection loss, on the one hand, and the parasitic inductance, on the other, which is observed in the circuit of FIG. 11.

### DETAILED DESCRIPTION OF THE INVENTION

Embodiments of the present invention will be described, with reference to the accompanying drawings. The components of each embodiment, which are identical in function and structure to those of any other embodiment, are designated at the same reference numerals in the drawings and will not be repeatedly described, except for some cases only, in this specification.

### First Embodiment

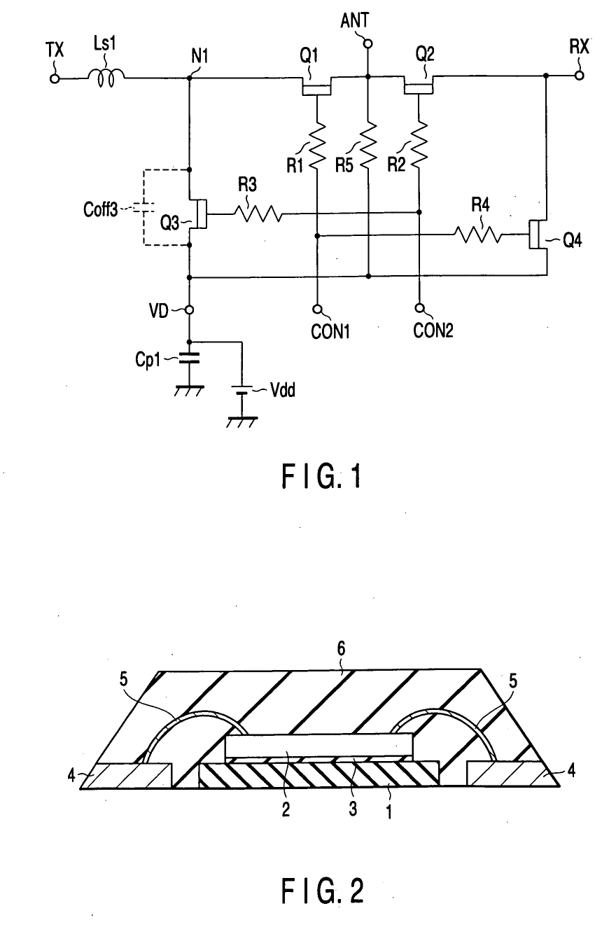

FIG. 1 is a circuit diagram that shows an SPDT switch according to the first embodiment of the invention. The SPDT switch has an antenna terminal ANT, a transmission terminal TX, a receipt terminal RX, two control terminals CON1 and CON2, and a power-supply voltage terminal VD.

The antenna terminal ANT is connected to an antenna. The transmission terminal TX is connected to the output of a high-frequency power amplifier (not shown) that is configured to amplify, for example, a signal to be transmitted. The signal to be transmitted is supplied to the transmission terminal TX. The receipt terminal RX is connected to the input of a receiving-side low noise amplifier (not shown). This terminal RX receives a signal from the antenna terminal ANT.

The power-supply voltage Vdd is applied to the power-supply voltage terminal VD. The terminal VD is connected to a decoupling capacitor Cp1, which is connected to the ground. In other words, the terminal VD is grounded for a high-frequency signal, and receives a power-supply voltage Vdd for a direct current (DC).

A control signal Vcon1 is supplied to the control terminal CON1. A control signal Von2 is supplied to the control terminal CON2. The control signals Vcon1 and Vcon2 are complementary to each other. The control signal Con1 or the control signal Con2 can be at high level (e.g., power-supply voltage Vdd) and low level (e.g., 0 V). The SPDT switch selects a transmission path or a reception path in accordance with the control signals Vcon1 and Vcon2.

The SPDT switch has a transmitting-side through-FET Q1, a receiving-side through-FET Q2, a transmitting-side shunt FET Q3, a receiving-side shunt FET Q4, and five resistors R1, R2, R3, R4 and R5.

The through-FET Q1 ha its drain electrode connected to a node N1 and its source electrode connected to the antenna terminal ANT. The shunt FET Q3 has its drain electrode connected to the node N1 and its source electrode connected to the power-supply voltage terminal VD. The node N1 is connected by a wire to the transmission terminal TX connected to a high power amplifier. The through-FET Q2 is provided between, and connected to, the terminals RX and ANT. The shunt FET Q4 is arranged between, and connected to, the terminals RX and VD.

The gate electrode of the through-FET Q1 is connected to the resistor R1, which is connected to the control terminal CON1. The gate electrode of the through-FET Q2 is connected to the resistor R2, which is connected to the control terminal CON2. The gate electrode of the shunt FET Q3 is connected to the resistor R3, which is connected to the control terminal CON2. The gate electrode of the shunt FET Q4 is connected to the resistor R4, which is connected to the control terminal CON1.

The resistor R5 connects the antenna terminal ANT to the power-supply voltage terminal VD. As can be understood from the above-described connection of components, all FETs provided in the SPDT switch have their source or drain electrodes set at a DC potential, i.e., the power-supply voltage Vdd. The resistors R1 to R5 are used to apply a bias voltage to the gate electrodes of the FETs and to intercept high-frequency signals. They have a resistance of, for example, about 10 kΩ.

FETs Q1, Q2, Q3 and Q4 have a negative threshold voltage Vth. The threshold voltage Vth falls within the range of 0 V to −|Vdd|V. The threshold voltage Vth is, for example, about −1 V if the power-supply voltage Vdd is about 3 V. The FETs incorporated in the SPDT switch are HEMTs (High Electron Mobility Transistors). They are formed in the same semiconductor substrate.

When the control signal Vcon1 is at the high level (e.g., 3 V) and the control signal Vcon2 is at the low level (e.g., 0 V), the through-FET Q1 and the shunt FET Q4 are on and the through-FET Q2 and the shunt FET Q3 are off. In this case, the terminals TX and ANT are connected, whereas the terminals ANT and RX are disconnected. Thus, the SPDT switch is set in the transmitting mode. When the control signal Vcon1 is at the low level and the control signal Vcon2 is at the high level, the through-FET Q1 and the shunt FET Q4 are off and the through-FET Q2 and the shunt FET Q3 are on. If this is the case, the terminals TX and ANT are disconnected, whereas the terminals ANT and RX are connected. Thus, the SPDT switch is set in the receiving mode.

The shunt FET Q3 is provided to isolate the terminals TX and ANT reliably from each other when these terminals TX and ANT are disconnected. Even if the through-FET Q1 is off, the signal received may leak to the terminal TX via the through-FET Q1. If this happens, the shunt FET Q3 guides this signal to the power-supply voltage terminal VD that is connected to the ground in high-frequency fashion. The shunt FET Q4 is used to isolate the terminals RX and ANT reliably from each other when these terminals RX and ANT are disconnected. Having shunt FETs, the SPDT switch is called a “shunt-type SPDT switch.”

The parasitic inductance Ls1 between the transmission terminal TX and the node N1, both shown in FIG. 1, is the sum of the parasitic inductance of the leads of the package and the parasitic inductance of the bonding wires. FIG. 2 is a sectional view of a packaged SPDT switch according to the first embodiment.

The circuit components of this SPDT are formed in an IC (Integrated Circuit) chip 2. The IC chip 2 is bonded at the lower surface to a package substrate 1, by an adhesive layer 3. Electrode pads (not shown) are provided on the upper surface of the IC chip 2. Bonding wires 5 connects the pads to leads 4. The bonding wires 5 are made of, for example, Au. The leads 4 are made of, for example, Cu. The leads 4 are connected to the terminals of external circuits (not shown). The IC chip 2 is sealed in a resin molding 6. The molding 6 is made of, for example, epoxy resin.

The node N1 shown in FIG. 1 corresponds to the electrode pads sown in FIG. 2. The terminal TX shown in FIG. 1 corresponds to the leads 4 shown in FIG. 2. The SPDT switch packaged as shown in FIG. 2 has parasitic inductance due to the leads 4 and parasitic inductance due to the bonding wires 5. It should be noted that this embodiment is not limited to a packaged SPDT switch. Rather, the embodiment can be an SPDT switch not packaged, which also has parasitic inductance resulting from the wires that connect the terminals to external circuits.

The shunt FET Q3 shown in FIG. 1 differs in structure from the other FETs Q1, Q2 and Q4 illustrated in FIG. 1, too. More specifically, the FET Q3 has a larger off-capacitance for unit gate width than the other FETs. The term “gate width” is a dimension measured in the direction of the channel width.

As indicated above, the transmission terminal TX is connected to the output of the high-frequency power amplifier that is a unit other than the SPDT switch. Usually, an output-matching circuit connects an SPDT switch to a high-frequency power amplifier. No output-matching circuits need to be used to connect the SPDT switch, i.e., the first embodiment, to a high-frequency power amplifier, for the following reason.

Any output-matching circuit to be connected to a high-frequency power amplifier comprises an inductor and a capacitor. The inductor is connected in series to a high-frequency signal path. The capacitor is connected between the output of the inductor and the ground. In the SPDT switch according to the present embodiment, the parasitic inductance Ls1 and the off-capacitance Coff3 of the shunt FET Q3 connected between the terminals TX and VD constitute an output-matching circuit.

Let us consider, for example, a 2.5-GHz power amplifier whose output impedance is 15 Ω before its output passes through an output-matching circuit. To change the output impedance to 50 Ω, a low-pass LC circuit may be used, which is constituted by an inductor (inductance: Lx) and a capacitor (capacitance: Cx). Inductance Lx and capacitance Cx should have the following values:
Lx≈1.5 nH
Cx≈2 pF

In the present embodiment, inductance Lx is realized as Ls1, i.e., the parasitic inductance of the leads 4 and the bonding wires 5, and capacitance Cx is realized as Coff3, i.e., the off-capacitance of the FET Q3. The ground-side terminal of off-capacitance Coff3 is connected to the bound by parasitic impedance. This parasitic impedance may influence the output-impedance characteristic of the 2.5-GHz power amplifier. In this case, it suffices to design the shunt FET Q3 so that a desired equivalent output impedance may be obtained.

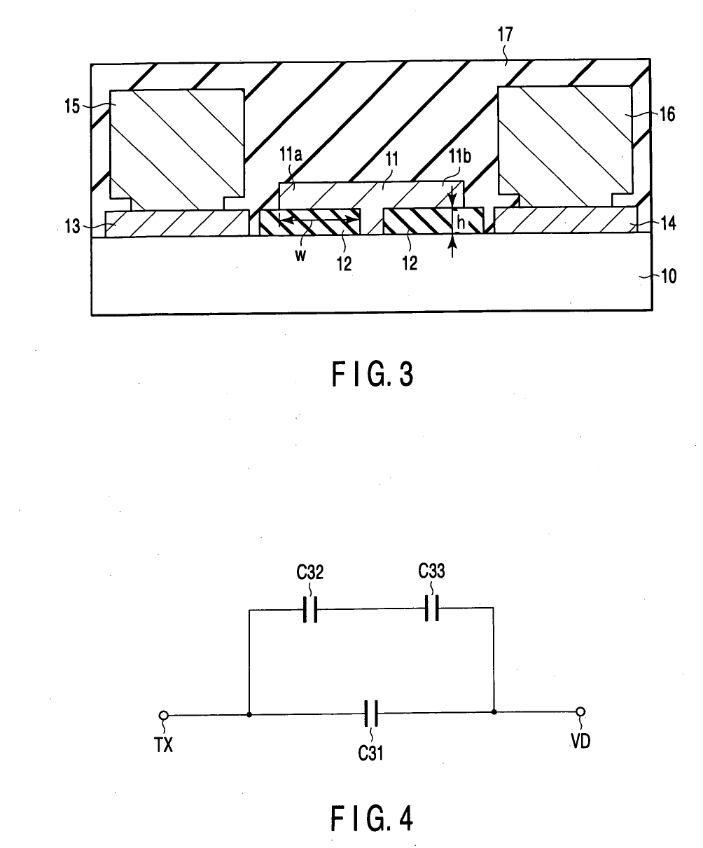

A method of increasing the off-capacitance Coff3 of the shunt FET Q3 to a value greater than the off-capacitance of the other FETs included in the SPDT switch will be explained. FIG. 3 is a sectional view illustrating the structure of the shunt FET Q3 shown in FIG. 1. As mentioned above, the FETs incorporated in the present embodiment are HEMTs. Nonetheless, they may be replaced by MESFETs (Metal Semiconductor Field-Effect Transistors) or by FETs of the ordinary type.

A gate electrode 11 is provided on a semiconductor substrate 10. The gate electrode 11 has a T-shaped cross section. More precisely, it has two overhangs 11a and 11b. It has been formed by depositing a Ti film, a Pt film and an Au film, one on another, in the order mentioned, or by depositing a Ti film and an Al film one on the other in the order mentioned. Two insulating films are provided, one between the overhang 11a and the substrate 10, and the other between the overhang 11b and the substrate 10. Both insulating films 12 are made of, for example, SiN.

A source electrode 13 is provided on one side of the gate electrode 11, and a drain electrode 14 on the other side of the gate electrode 11. On the source electrode 13 there is formed a metal wire 15. The wire 15 is connected to the power-supply voltage terminal VD. A metal wire 16 is formed on the drain electrode 14 and is connected by the node N1 to the transmission terminal TX connected to a high power amplifier. An inter-layer insulating layer 17 is formed on the semiconductor substrate 10. The layer 17 is made of, for example, SiN.

If the FETs are all HEMTs, the semiconductor substrate 10 has a base (made of, for example, GaAs), a channel layer (made of, for example, InGaAs) formed on the base, and an electron-supplying layer (made of, for example, AlGaAs) formed on the channel layer. The channel layer is an undoped one that has a low impurity-ion concentration. The electron-supplying layer is a doped one that has a high impurity-ion concentration.

In the this embodiment, i.e., SPDT switch according to the invention, the FETs Q1, Q2 and Q4 have a T-shaped gate electrode each. The FET Q3 has overhangs having a greater height h or a greater length w than the overhangs of the other FETs. Hence, the FET Q3 can have a larger off-capacitance for unit gate width than the other FETs.

FIG. 4 is an equivalent-circuit diagram of the off-capacitance at the shunt FET Q3 shown in FIG. 3. Capacitance C31 is the off-capacitance that the shunt FET Q3 should have if no overhangs were provided. Capacitance C32 is the capacitance provided between the overhang 11b and the semiconductor substrate 10. Obviously, the T-shaped gate electrode 11 imparts a large off-capacitance to the shunt FET Q3.

Assume that the overhangs of the FET Q3 have a height h of 50 nm and a length w of 2 μm. Then, the off-capacitance that the FET Q3 has for unit gate width is 1.33 pF/mm. It follows that the FET Q3 can have off-capacitance Coff3 of 2 pF if it has a gate width of 1.5 mm.

It is desired that the FETs Q1, Q2 and Q4 should have small capacitance for achieve desirable isolation. Assume that, in each of these FETs, the overhangs of the gate electrode have a height h of 50 nm and a length w of 0.2 μm. Then, the off-capacitance that the FET Q3 has for unit gate width is 310 pF/mm. If the FET Q3 had a gate electrode having such short overhangs, its gate width would be 6.4 mm, inevitably increasing the chip area. Therefore, the gate electrode of the FET Q3 should not have such short overhangs.

Hence, the FETs Q1, Q2 and Q4 may have a straight gate electrode (i.e., electrode without overhangs, w=0), while only the FET Q3 has a T-shaped gate electrode. If the FETs Q1, Q2 and Q4 FET Q3 have a straight gate, the off-capacitance that they have for unit gate width will be 240 fF/mm. That is, they have a small off-capacitance. This improves the characteristics of the SPDT switch. If the FET Q3 had a straight gate electrode, its gate width should be 8.3 mm, inevitably increasing the chip area.

Having the structure specified above, the SPDT switch renders it unnecessary to connect an output-matching circuit to the high-frequency power amplifier that is a chip provided on, for example, a mother board. Parasitic inductance Ls1 and off-capacitance Coff3, which may result in a transmission loss and a reflection loss, respectively, constitute an output-matching circuit. Thus, the SPDT switch is considered to have neither parasitic inductance Ls1 nor off-capacitance Coff3. Therefore, the transmission loss can be decreased in the SPDT switch.

Simulation was performed on an SPDT switch according to the first embodiment in order to determine the relation between the transmission loss and reflection loss, on the one hand, and the parasitic inductance, on the other, applying the same conditions as specified with reference to FIG. 12. The simulation showed that the transmission loss was 0.284 dB when the inductance Ls was 1.5 nH. This transmission loss is about half the transmission loss of 0.605 dB in the conventional SPDT switch shown in FIG. 10.

As described above in detail, the shunt FET Q3 has a greater off-capacitance than the other FETs in the SPDT switch, i.e., the first embodiment. The parasitic inductance inevitably present in the switch circuit is positively utilized. In addition, the off-capacitance and parasitic inductance in the shunt FET Q3 can achieve impedance matching between the SPDT switch and the high-frequency power amplifier connected to the SPDT switch.

The first embodiment can, therefore, accomplish impedance matching between the SPDT switch and the high-frequency power amplifier, without the necessity of connecting an output-matching circuit between the SPDT switch and the power amplifier. This makes it possible to reduce the circuit area and the manufacturing cost. Since parasitic inductance Ls1 and off-capacitance Coff3 are, so to speak, eliminated, the power loss in high-frequency signals can be minimized.

The inductance Lx of the output-matching circuit may need to have a greater value than specified for the present embodiment. In this case, it suffices to lengthen the boding wires 5. Conversely, to impart a smaller inductance to the output-matching circuit, the bonding wires 5 may be arranged parallel to one another. The inductance Lx may have a desired value by using a package that has a relatively small parasitic inductance at the leads 4.

In the firs embodiment described above, the gate electrode 11 of the shunt FET Q3 has overhangs having a height h of 50 nm. The height h of each overhang can, of course, be reduced in order to increase the off-capacitance Coff3 of the shunt FET Q3. To increase the off-capacitance Coff3, the material of the gate electrode 11 or the material of the insulating films 12, or both, may be changed.

The SPDT switch described above is packaged. Nonetheless, the first embodiment can provide an SPDT switch that is not packaged. This SPDT switch and external circuits are mounted on the same dielectric substrate and are connected by using patterned wires or bonding wires. In this case, the parasitic inductance of the wires and the off-capacitance Coff3 of the shunt FET Q3 constitute an output-matching circuit. The transmission loss can therefore be reduced. Further, the circuit area and manufacturing cost of the SPDT switch can be decreased.

The SPDT switch may not be packaged. In this case, too, the output-matching circuit can have a sufficient capacitance, owning to the specific structure of the shunt FET Q3. Hence, the inductance of the output-matching circuit may be provided outside the SPDT switch.

The first embodiment may be applied to the input-matching circuit to be connected to the receipt terminal RX connected to a low noise amplifier. This provides the same advantages as pointed out above.

### Second Embodiment

The second embodiment of the invention is an SPDT switch, too. This SPDT switch has metal wires that differ in shape from those used in the first embodiment. The shunt FET Q3 therefore has a larger off-capacitance than its counterpart of the first embodiment.

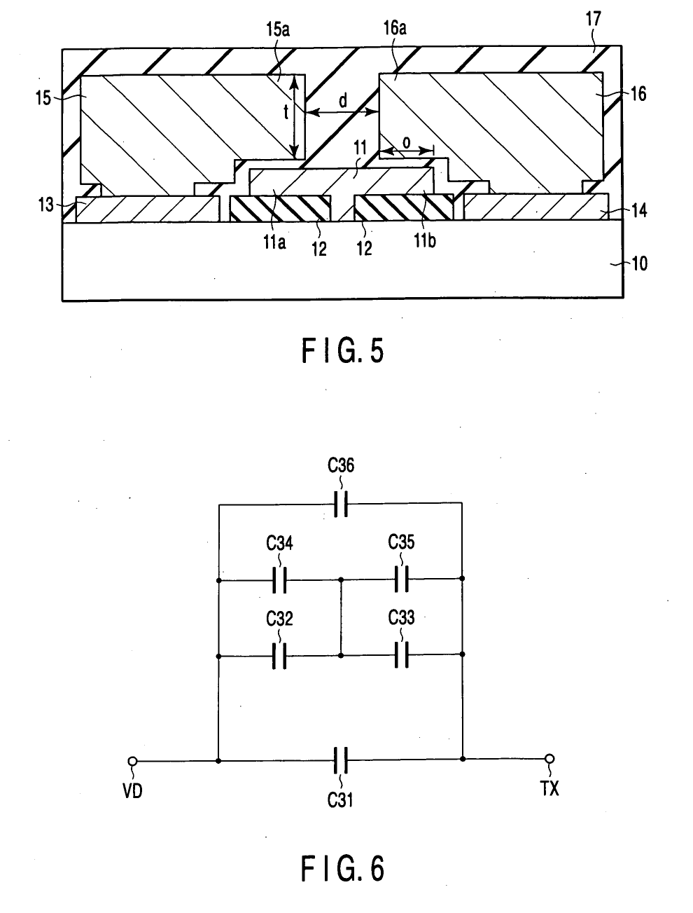

FIG. 5 is a sectional view depicting the structure of the transmitting-side shunt FET Q3 incorporated in the SPDT switch according to the second embodiment. A metal wire 15 has an overhang 15a that overlaps the gate electrode 11. An inter-layer insulating layer 17 fills the gap between the gate electrode 11 and the overhang 15a. A metal wire 16 has an overhang 16a that overlaps the gate electrode 11. The inter-layer insulating layer 17 fills the gap between the gate electrode 11 and the overhang 16a. Note that the gate electrode 11 has two overhangs 11a and 11b as in the first embodiment.

FIG. 6 is an equivalent-circuit diagram of the off-capacitance at the shunt FET Q3 shown in FIG. 5. Capacitance C34 is capacitance that is provided between the overhangs 11a and 15a. Capacitance C35 is capacitance that is provided between the overhang 11b and the overhang 16a. Capacitance 36 is capacitance that is provided between the overhang 15a and the overhang 16a. The use of the metal wires 15 and 16, both shown in FIG. 5, increases the off-capacitance Coff3 of the shunt FET Q3.

Assume that the overhangs of the FET Q3 have a height h of 50 nm and a length w of 2 μm. Also, assume that the metal wires 15 and 16 overlap the gate electrode for a distance o of 2 μm, and that the metal wires 15 and 16 have a thickness t of 1 μm and are spaced apart by a distance d of 1 μm. Then, the off-capacitance that the FET Q3 has for unit gate width is 2.54 pF/mm. It follows that the FET Q3 can have off-capacitance Coff3 of 2 pF if it has a gate width of 0.79 mm.

Thus, the second embodiment attains the same advantages as the first embodiment. Further, the FET Q3 can acquire off-capacitance Coff3 of a desired value by changing the shape of the metal wires 15 and 16 in the case where the FET Q3 cannot acquire off-capacitance Coff3 of the desired value by changing the shape of the gate electrode 11.

The off-capacitance Coff3 can of the value desired without increasing the length w of the gate electrode 11. This helps to reduce the circuit area of the SPDT switch.

### Third Embodiment

The third embodiment of the invention is also an SPDT switch. This SPDT switch has a shunt FET Q3 that is a multi-gate FET. Namely, the shunt FET Q3 has a plurality of gates and therefore exhibits a high withstand voltage to the input signal. Including a multi-gate FET, the SPDT switch has a high withstand voltage to high-frequency signals.

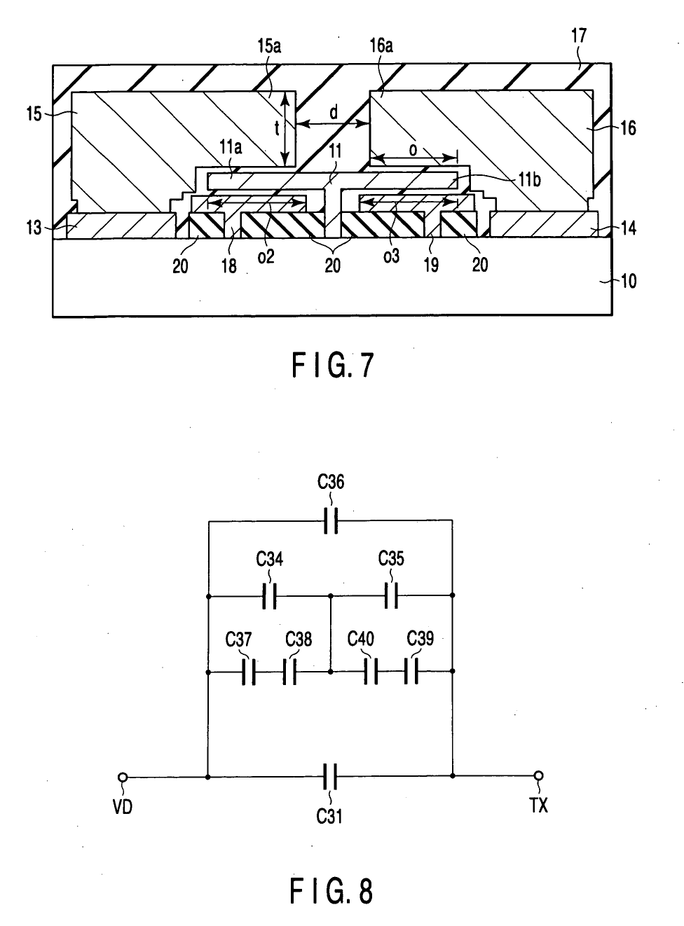

FIG. 7 is a sectional view depicting the structure of the transmitting-side shunt FET Q3 provided in the third embodiment. As seen from FIG. 7, the shunt FET Q3 is a triple-gate FET, i.e., an FET having three gate electrodes 11, 18 and 19.

The gate electrodes 18 and 19, each having a T-shaped cross section, are formed on the semiconductor substrate 10. Insulating films 20 are provided between the overhangs of the gate electrode 18 and the semiconductor substrate 10. Insulating films 20 are interposed between the overhangs of the gate electrode 19 and the semiconductor substrate 10. The insulating films 20 are made of, for example, SiN.

The gate electrode 11 has overhangs 11a and 11b. The overhangs 11a and 11b are provided above the gate electrode 18 and gate electrode 19, respectively. An inter-layer insulating layer 17 fills the gap between the overhang 11a and the gate electrode 18, and the gap between the overhang 11b and the gate electrode 19.

Two metal wires 15 and 16 are provided each having an overhang. The inter-layer insulating layer 17 fills the gap between the gate electrode 11 and the overhang 15a of the metal wire 15. Similarly, the layer 17 fills the gap between the gate electrode 11 and the overhang 16a of the metal wire 16.

The SPDT switch according to the third embodiment has FETs Q1, Q2 and Q4, like those according to the first and second embodiments. The FETs Q1, Q2 and Q4 have a T-shaped gate electrode having short overhangs. Alternatively, they have a straight gate electrode.

FIG. 8 is an equivalent-circuit diagram of the off-capacitance at the shunt FET Q3 shown in FIG. 7. Capacitance C37 is capacitance that is provided between the semiconductor substrate 10 and the gate electrode 18. Capacitance C38 is capacitance that is provided between the gate electrode 18 and the overhang 11a. Capacitance C39 is one that is provided between the semiconductor substrate 10 and the gate electrode 19. Capacitance C40 is one that is provided between the gate electrode 19 and the overhang 11b. Having the multi-gate FET shown in FIG. 7, the shunt FET Q3 can have a large off-capacitance Coff3.

Assume that the overhangs of the gate electrodes 18 and 19 have a height of 50 μm, the overhang 11a and the gate electrode 18 are spaced by 50 μm, the overhang 11b and the gate electrode 19 are spaced by 50 μm, the overhangs 11a and 15a are spaced apart by 50 μm, and the overhangs 11b and 16b are spaced apart by 50 μm. Also, assume that the gate electrodes 11 and 18 overlap for a distance o2 of 2 μm, the gate electrodes 11 and 19 overlap for a distance o3 of 2 μm, the metal wires 15 and 16 overlap the gate electrode 11 for a distance o of 2 μm. Further, assume that the metal wires 15 and 16 have a thickness t of 1 μm and the metal wires 15 and 16 are spaced apart by a distance d of 1 μm. Then, the off-capacitance that the FET Q3 has for unit gate width is 1.63 pF/mm. Hence, the FET Q3 can have off-capacitance Coff3 of 2 pF if it has a gate width of 1.23 mm.

Thus, the third embodiment can have the same advantages as the first embodiment.

The shunt FET Q3 used in this embodiment is a triple-gate FET. Nevertheless, a multi-gate FET whose gate electrodes is three or more may replace it. In such a case, too, the advantages of the invention will be attained.

### Fourth Embodiment

The fourth embodiment of this invention is a high-frequency transmitting/receiving apparatus 300 that comprises an SPDT switch 100 and a high-frequency power amplifying circuit 200.

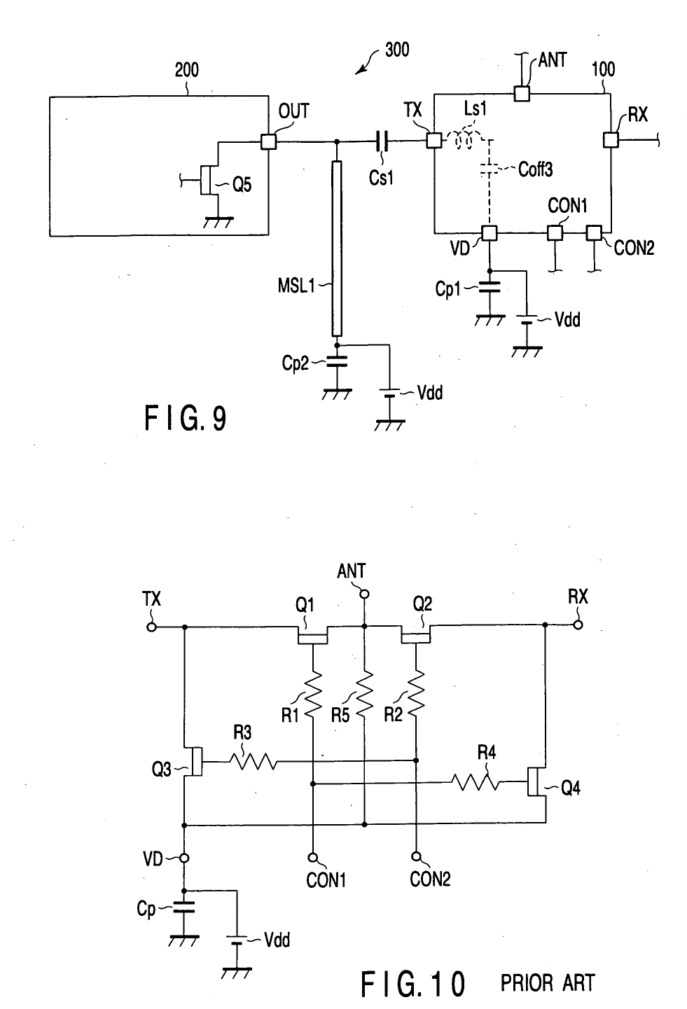

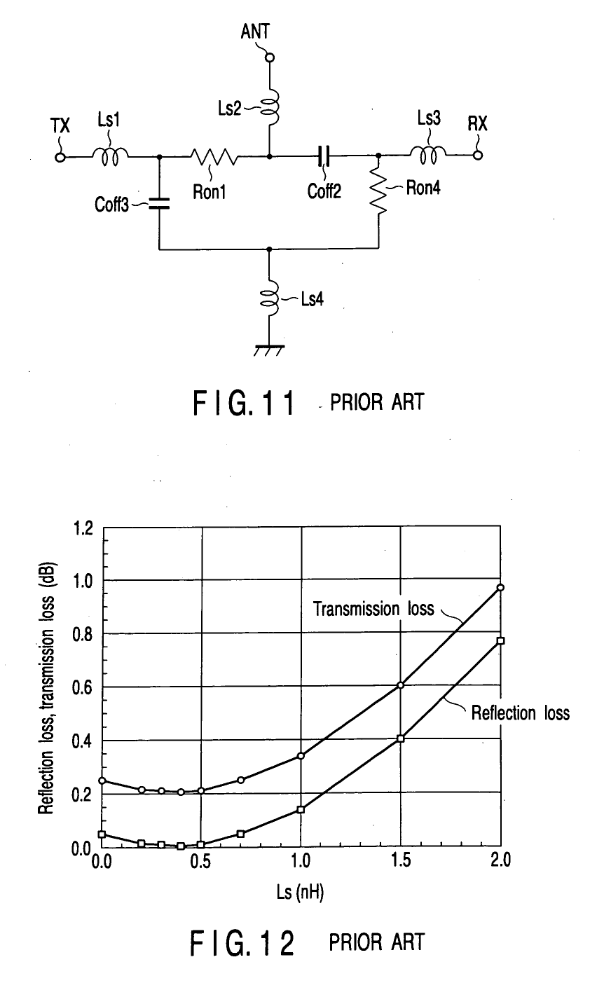

FIG. 9 is a circuit diagram showing the configuration of a high-frequency transmitting/receiving apparatus 300. As FIG. 9 shows, the high-frequency power amplifying circuit 200 has a high-frequency power amplifier Q5. The power amplifier Q5 amplifies a signal that the apparatus 300 will transmit. The drain electrode of the power amplifier Q5 (or the collector, if the amplifier Q5 is a bipolar transistor) is connected to the output terminal OUT.

An inductor MSL1 is provided to supply a DC bias current to the drain electrode of the high-frequency power amplifier Q5. The inductor MSL1 has one end connected to the output terminal OUT, and the other end connected to the power-supply voltage Vdd. The inductor MSL1 is a high impedance when it receives a high-frequency current, and a low impedance when it receives a DC current. The inductor MSL1 exhibits infinite impedance to signals of any high-frequency signals. It is desired that the indictor MSL1 be a λ/4 line that has no impedance to twice the frequency of the high-frequency signal (λ is the wavelength of the signal).

The other end of the inductor MSL1 is connected to a decoupling capacitor Cp2, which is connected to the ground. Thus, the other end of the inductor MSL1 is grounded for a high-frequency signal.

A capacitor Cs1 connects the output terminal OUT and the transmission terminal TX of the SPDT switch 100. The capacitor Cs1 is used to isolate the SPDT switch 100 and the power amplifier circuit 200 from each other, with regard to DC currents.

The SPDT switch 100 is identical in configuration to the SPDT switch according to any embodiment described above. The antenna terminal ANT is connected to an antenna. The receipt terminal RX is connected to the input of a receiving-side amplifier (not shown). A signal received is supplied from the receipt terminal RX.

The power-supply voltage terminal VD receives the power-supply voltage Vdd. The terminal VD is connected to a decoupling capacitor Cp1, which is connected to the ground. Thus, the terminal VD is grounded for a high-frequency signal, and receives the power-supply voltage Vdd for DC.

A control terminal CON1 receives a control signal Vcon1. A control terminal CON1 receives a control signal Vcon2. The control signals Vcon1 and Vcon2 are complementary to each other. The control signal Con1 or the control signal Con2 can be at high level (e.g., power-supply voltage Vdd) and low level (e.g., 0 V). The SPDT switch 100 selects a transmission path or a reception path in accordance with the control signals Vcon1 and Vcon2.

In the high-frequency transmitting/receiving apparatus 300 thus configured, the high-frequency signal to be transmitted is supplied from the output terminal OUT to the terminal TX of the SPDT switch 100, without passing through an output-matching circuit (which may perform impedance matching between the power amplifier circuit 200 and the SPDT switch 100). The output impedance of the high-frequency power amplifier Q5 is changed by an LC circuit provided in the SPDT switch 100. (The LC circuit comprises a parasitic inductance Ls1 and the off-capacitance Coff3 of the transmitting-side shunt FET Q3.) If the power amplifier Q5 is a 2.5-GHz power amplifier having an output impedance of 15 Ω, the LC circuit changes this output impedance to 50 Ω.

In the fourth embodiment described above, impedance matching can be accomplished without providing an output-matching circuit between the SPDT switch 100 and the high-frequency power amplifying circuit 200. This can reduce the circuit area of the and lower the transmitting/receiving apparatus 300 and lowers the manufacturing cost of the apparatus 300. Moreover, the power loss in any high-frequency signal that is to be transmitted can be decreased because the parasitic inductance Ls1 and the off-capacitance Coff3 are, so to speak, eliminated.

If the SPDT switch 100 is not packaged, it may fail to acquire parasitic inductance Ls1 of a desired value. Even in this case, an output-matching circuit need not be used for two reasons. First, the amplifier circuit 200 and the SPDT switch 100 are mounted on the same dielectric substrate. Second, the output terminal OUT and the transmission terminal TX are connected by using wires having parasitic inductance (e.g., bonding wires). The high-frequency transmitting/receiving apparatus 300, thus configured, achieves the same advantages as the first embodiment.

An output-matching circuit for the amplifier circuit 200 may be provided between the output terminal OUT and the transmission terminal TX. If this is the case, the LC circuit provided in the SPDT switch 100 reduces the reflection loss, imparting good characteristics to the high-frequency transmitting/receiving apparatus 300.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A high-frequency switch circuit which switches between a transmitting mode of inputting and outputting a transmission signal and a receiving mode of inputting and outputting a reception signal, said circuit comprising:
a first terminal which receives the transmission signal;
a first FET (field-effect transistor) which makes a path of the transmission signal conductive or cut off;
a second terminal which receives a control signal that is inactive in the transmitting mode and is active in the receiving mode;
a ground terminal which is grounded via a first capacitor; and
a second FET which has a drain electrode, a source electrode and a gate electrode, the drain or source electrode being connected to the ground terminal, the source or drain electrode being connected to first terminal, and the gate electrode being connected to the second terminal, and which has a greater off-capacitance for unit gate width than the first FET.

2. The switch circuit according to claim 1, wherein the gate electrode of the second FET is formed on a semiconductor substrate, is T-shaped and has two overhangs.

3. The switch circuit according to claim 2, wherein a gate electrode of the first FET has two overhangs, and the overhangs of the second FET lie at a level higher than those of the first FET, from a surface of the semiconductor substrate.

4. The switch circuit according to claim 2, wherein a gate electrode of the first FET has two overhangs, and the overhangs of the second FET are longer than those of the first FET.

5. The switch circuit according to claim 2, further comprising a first insulating film provided between the semiconductor substrate and the overhangs of the second FET.

6. The switch circuit according to claim 1, further comprising a first wiring portion connecting a first node to the first terminal, wherein,
the drain or source electrode of the first FET is connected to the first terminal by the first node;
the second FET is connected to the first terminal by the first node; and
the second FET has an off-capacitance and the first wiring portion has inductance, said off-capacitance and said inductance performing impedance matching on a high-frequency power amplifier connected to the first terminal.

7. The switch circuit according to claim 6, wherein the off-capacitance of the second FET changes an output impedance of the high-frequency power amplifier to a predetermined value.

8. The switch circuit according to claim 6, which is sealed in a package substrate and in which the first wiring portion includes a bonding wire.

9. The switch circuit according to claim 8, wherein the first wiring portion includes a lead which electrically connected to an external terminal.

10. The switch circuit according to claim 1, which is provided on a dielectric substrate having a high-frequency power amplifier, which further comprises a second wiring portion connecting an output of the high-frequency power amplifier to the first terminal, and in which the second FET has an off-capacitance and the second wiring portion has inductance, said off-capacitance and said inductance performing impedance matching on the high-frequency power amplifier.

11. The switch circuit according to claim 10, wherein the second wiring portion includes a bonding wire.

12. The switch circuit according to claim 1, further comprising:
a second insulating film which is provided on the gate electrode of the second FET; and
a first conductive layer which has an overhang connected to the drain source of the second FET and provided on the second insulating film.

13. The switch circuit according to claim 1, further comprising:
a third insulating film which is provided on the gate electrode of the second FET; and
a second conductive layer which has an overhang connected to the source electrode of the second FET and provided on the third insulating film.

14. The switch circuit according to claim 1, wherein;
the second FET is a multi-gate FET having first and second gate electrodes, which are T-shaped and have two overhangs each;
the second gate electrode is arranged below one of the overhangs of the first gate electrode; and
a fourth insulating film is interposed between the second gate electrode and said one of the overhangs.

15. The switch circuit according to claim 1, wherein;
the second FET is a multi-gate FET having first, second and third gate electrodes, which are T-shaped and have two overhangs each;
the second gate electrode is arranged below one of the overhangs of the first gate electrode;
a fourth insulating film is interposed between the second gate electrode and said one of the overhangs of the first gate electrode;
the third gate electrode is arranged below the other of the overhangs of the first gate electrode; and
a fifth insulating film interposed between the third gate electrode and said other of the overhangs of the first gate electrode.

16. The switch circuit according to claim 1, wherein each of the FETs is a MESFET (metal-semiconductor field-effect transistor) or a HEMT (high electron mobility transistor).

17. A high-frequency transmitting/receiving apparatus comprising:
a dielectric substrate;
a high-frequency power amplifier which is provided on the dielectric substrate and which amplifies a transmission signal;
an inductor connected at one end to a power-supply voltage and at the other end connected to an output of the high-frequency power amplifier; and
a high-frequency switch circuit which is provided on the dielectric substrate, which is sealed in a package substrate and which switches between a transmitting mode of inputting and outputting the transmission signal and a receiving mode of inputting and outputting a reception signal, said switch circuit comprising:
a first terminal which receives the transmission signal;
a wiring portion which connects a first node to the first terminal;
a first FET which has a drain electrode, a source electrode and a gate electrode, the drain or source electrode being connected to the first node, and which makes a path of the transmission signal conductive or cut off;
a second terminal which receives a control signal that is inactive in the transmitting mode and is active in the receiving mode;
a ground terminal which is grounded via a first capacitor; and
a second FET which has a drain electrode, a source electrode and a gate electrode, the drain or source electrode being connected to the first node, the source or drain electrode being connected to the ground terminal, and the gate electrode being connected to the second terminal, and which has a greater off-capacitance for unit gate width than the first FET,
the second FET having an off-capacitance, and the wiring portion having inductance, said off-capacitance and said inductance performing impedance matching on the high-frequency power amplifier.

18. The transmitting/receiving apparatus according to claim 17, wherein the off-capacitance of the second FET changes an output impedance of the high-frequency power amplifier to a predetermined value.

19. The transmitting/receiving apparatus according to claim 17, wherein the gate electrode of the second FET is T-shaped and has two overhangs.

20. A high-frequency transmitting/receiving apparatus comprising:
a dielectric substrate;
a high-frequency power amplifier which is provided on the dielectric substrate and which amplifies a transmission signal;
an inductor connected at one end to a power-supply voltage and at the other end connected to an output of the high-frequency power amplifier; and
a high-frequency switch circuit which is provided on the dielectric substrate and which switches between a transmitting mode of inputting and outputting the transmission signal and a receiving mode of inputting and outputting a reception signal, said switch circuit comprising:
a first terminal which receives the transmission signal;
a first FET which makes a path of the transmission signal conductive or cut off;
a second terminal which receives a control signal that is inactive in the transmitting mode and is active in the receiving mode;
a ground terminal which is grounded via a first capacitor;
a second FET which has a drain electrode, a source electrode and a gate electrode, the drain or source electrode being connected to the first terminal, the source or drain electrode being connected to the ground terminal, and the gate electrode being connected to the second terminal, and which has a greater off-capacitance for unit gate width than the first FET, and
a wiring portion which connects the first terminal to the output of the high-frequency power amplifier,
the second FET having an off-capacitance, and the wiring portion having inductance, said off-capacitance and said inductance performing impedance matching on the high-frequency power amplifier.
